(19) United States
(12) Patent Application Publication
(10) Pub. No.: US 2022/0311111 A1
(43) Pub. Date: Sep. 29, 2022

(54) Primary Battery Electric Generating Appliance

(71) Applicant: Tyson Manny Davila, Columbia, CT (US)

(72) Inventor: Tyson Manny Davila, Columbia, CT (US)

(21) Appl. No.: 17/213,242

(22) Filed: Mar. 26, 2021

(51) Int. Cl. H01M 50/673; H01M 6/50; H01M 6/42; H01M 6/04; H01M 50/51; H01M 50/691; H01M 50/609; H01M 50/30

(52) U.S. Cl. CPC H01M 50/673; H01M 6/5011; H01M 6/42; H01M 6/04; H01M 50/51; H01M 50/691; H01M 50/609; H01M 50/394

(57) ABSTRACT

An electric generating appliance that supplies a fixed voltage through a voltage regulator connected to one or more primary batteries comprised of cells made of solid metal anodes and solid metal cathodes where the metal for the solid metal anodes is a different type of metal than the metal used for the solid metal cathodes and where each cell has an output duct to expel air or aqueous electrolyte and an input duct to receive air, aqueous electrolyte, or a humidified electrolyte from a circuit-controlled pump connected to a refillable electrolyte container.

### TECHNICAL FIELD

This invention generally relates to batteries and the direct conversion of chemical energy into electrical energy. More specifically, this invention relates to galvanic primary cells or batteries with an aqueous electrolyte wherein the galvanic primary cells or batteries are used as the power source for electric generating appliances that use a pump to supply the aqueous electrolyte to the primary cells.

### BACKGROUND

Electric generators are backup power sources that convert a fuel supply, usually propane, diesel, or gasoline, into electrical energy. There are three types of generators, portable, inverter and standby. Portable generators are powered by gas or diesel fuel and can provide temporary electrical power. Portable generators use a combustion engine to conduct electricity, can plug into electrical appliances or tools through its electric outlets, can be wired into a facility's electric panels, can be used in remote sites, has enough power to run a television, freezer, refrigerator, power tools and lights, and renders standard 50 hz or 60 hz current. An inverter generator uses an engine connected to an alternator to produce AC power and a rectifier to produce DC power. Inverter generators rely on high-tech magnets, use advanced electronic circuitry, outputs AC current, convert it to DC current, and then convert it back to AC, can be set to any voltage or AC frequency, can fit into a car, RV, or boat. A standby generator is an electric system that operates with an automatic transfer switch that commands it to power a device during power loss. Standby generators operate automatically, deliver permanent power protection, comprise of an automatic transfer switch and a standby generator, can rely on the fuel type already used in a home such as liquid propane or natural gas, uses an internal combustion engine, senses power loss within seconds and boots up electricity so that the power loss is felt very briefly, constantly monitors utility power, and is used in safety systems for elevators, standby lighting, medical and life support equipment and fire protection systems.

Primary batteries on the other hand are batteries that cannot be recharged because they convert chemical energy into electrical energy and the process cannot be reversed. The chemical reactions that, take place inside the primary battery cells cause the flow of electrons producing electricity. The cells in primary batteries are known as galvanic cells or voltaic cells. Voltaic cells can be created by placing two different metals in contact with an electrolyte. The cells stop working once the electrolyte dries out or when the cells components are consumed by the electricity producing chemical reactions. Since primary batteries cannot be recharged, they are typically used for standalone applications where the voltage requirements are low, such as to power remote controls, toys, flashlights, or pacemaker's that can last 5-10 years.

A need exists for an electric generating appliance powered by primary batteries that combines the advantages of electric generators and primary batteries without their major shortcomings. Electric generators can be used for heavy loads but are limited because they require advanced components and combustion engines powered by fossil fuels that produce deadly carbon monoxide as they operate. Primary batteries are safe to use indoors but are limited because they cannot be recharged so they are used for low voltage scenarios instead of serving as backup power sources to power televisions, freezers, refrigerators, power tools and other heavy loads.

Prior art exists that improves primary batteries. For example, U.S. Pat. No. 7,633,261 uses a voltage regulator that is integrated within the battery cell assembly to regulate a DC output voltage of 1.5 V, 3.0 V or 3.9 V in standard D, C, AA, or AAA batteries. U.S. Patent Application 20120058369 describes an electrolyte rechargeable battery, such as a flooded lead-acid battery between 12 and 60 volts with a pump to refill the electrolyte fluid that is lost during out-gassing when the battery is electrically recharged and can be used for emergency or standby power supplies or to power heavy loads such as golf carts, electric cars, and forklifts.

The Primary Battery Electric Generating Appliance addresses the need to combine the advantages of electric generators and primary batteries because it is an electric generating appliance powered by primary batteries, does not have a combustion engine or use fossil fuels that emit deadly carbon monoxide during operation, can plug into electrical appliances or tools through its electric outlets, can be wired into a facility's electric panels, can be used in remote sites, has enough power to run a television, freezer, refrigerator, power tools, lights and other heavy loads, can render standard 50 hz or 60 hz current, does not require high-tech magnets, does not use advanced electronic circuitry, can be set to any voltage or AC frequency by replacing its circuit box configured to the required voltage and frequency can fit into a car, RV, or boat and can be used for backup or emergency power.

### SUMMARY OF THE INVENTION

The invention relates to an electric generating appliance that supplies a fixed voltage through a voltage regulator connected to one or more primary batteries comprised of cells made of solid metal anodes and solid metal cathodes where the metal for the solid metal anodes is a different type of metal than the metal used for the solid metal cathodes and where each cell has an output duct to expel air or aqueous electrolyte and an input duct to receive air, aqueous electrolyte, or a humidified electrolyte from a circuit-controlled pump connected to a refillable electrolyte container.

### BRIEF DESCRIPTION OF THE DRAWINGS

FIG. 1 is the Primary Battery Electric Generating Appliance shown from the top, front and right sides.

FIG. 2 is a see-through view of the Primary Battery Electric Generating Appliance shown from the top, front and right sides.

FIG. 3 is the Primary Battery Electric Generating Appliance shown from the top, back and left sides.

FIG. 4 is a see-through view of the Primary Battery Electric Generating Appliance shown from the top, back and left sides.

FIG. 5 is the Main Chassis without the Main Chassis Lid in an aerial view.

FIG. 6 is a cut out view of the front and back sides of the Main Chassis.

FIG. 7 is the Humidified Electrolyte Primary Battery shown from the top, front and right sides.

FIG. 8 is a see-through view of the Humidified Electrolyte Primary Battery shown from the top, front and right sides.

FIG. 9 is the Humidified Electrolyte Primary Battery shown from the top, back and left sides.

FIG. 10 is a see-through view of the Humidified Electrolyte Primary Battery shown from the top, back and left sides.

FIG. 11 is a partial aerial view of the Humidified Electrolyte Primary Battery shown without the Primary Battery's Lid.

FIG. 12 is the Humidified. Electrolyte Primary Battery shown split in half through one of its Cells.

FIG. 13 is the Humidified Electrolyte Primary Battery shown with its right side sliced through the input ducts and input nozzle.

FIG. 14 is the Humidified Electrolyte Primary Battery shown with its left side sliced through the exhaust ducts and exhaust nozzle.

FIG. 15 is the Circuit Box shown from the top, front and right sides.

FIG. 16 is the Circuit Box shown from the top, back and left sides.

FIG. 17 is the Circuit Box shown in an aerial view without the Circuit Box Lid.

FIG. 18 is the Electrolyte Humidifier Pump shown from the top, front and right sides.

FIG. 19 is the Electrolyte Humidifier Pump shown from the top, back and left sides.

FIG. 20 is a see-through view of the Electrolyte Humidifier Pump.

### DETAILED DESCRIPTION OF CERTAIN EMBODIMENTS

The invention, a Primary Battery Electric Generating Appliance, is an electric generating appliance that supplies a fixed voltage through a voltage regulator connected to replaceable primary batteries comprised of cells made of solid metal anodes and solid metal cathodes where the metal for the solid metal anodes is a different type of metal than the metal used for the solid metal cathodes and where each cell has an output duct to expel air or aqueous electrolyte and an input duct to receive air, aqueous electrolyte, or a humidified electrolyte from a circuit-controlled pump connected to a refillable electrolyte container. The electric generating appliance has an electric outlet that provides alternating current from an inverter connected to the voltage regulator.

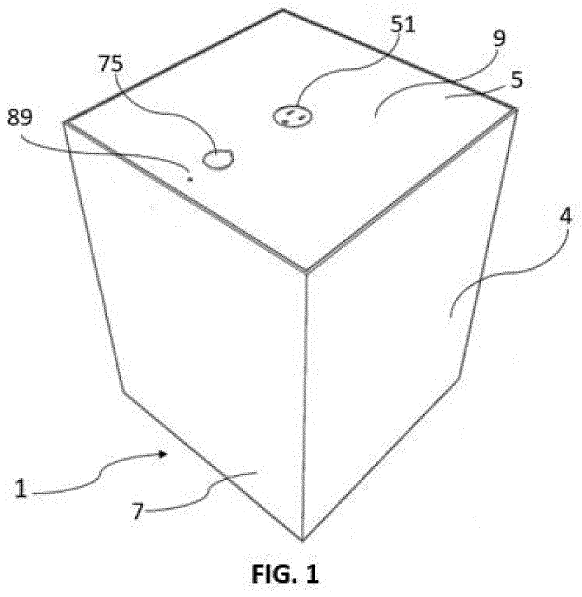

FIG. 1 is the Primary Battery Electric Generating Appliance 1 shown from the top 5, front 7 and right 4. From the top side 5 we can see main chassis lid 9, main air intake and exhaust vent 89, electrolyte container lid 75 and electric outlet 51.

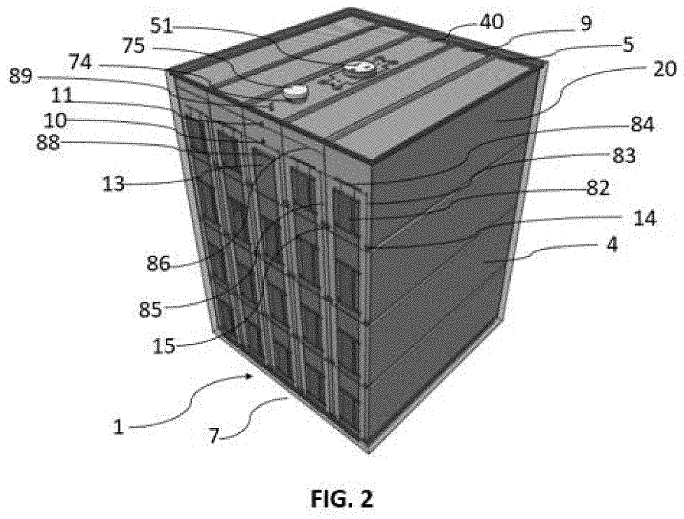

FIG. 2 is a see-through view of the Primary Battery Electric Generating Appliance 1 shown from the top 5, front 7 and right 4. The Primary Battery Electric Generating Appliance 1 is equipped with nineteen Humidified Electrolyte Primary Batteries 20 and Circuit Box 40. From front side 7 we can see the entry point for positive wires 88 through which wires run into the positive wire ducts 13 to the nineteen positive metal bands 82. From front side 7 we can also see the main electrolyte and air input nozzle 10 that connects to horizontal input duct 84. Horizontal input duct 84 connects to the vertical input ducts 83 that supply the humidified electrolyte to the nineteen slots for the primary battery input nozzles 14. From the front side 7 we can also see the main exhaust nozzle 11 that connects to horizontal exhaust duct 86. Horizontal exhaust duct 86 connects to vertical exhaust ducts 85 that allow exhaust to exit the nineteen slots for the primary battery exhaust nozzles 15. From the top side 5, we can see main chassis lid 9, main air intake and exhaust vent 89, refillable electrolyte container 74, electrolyte container lid 75 and electric outlet 51.

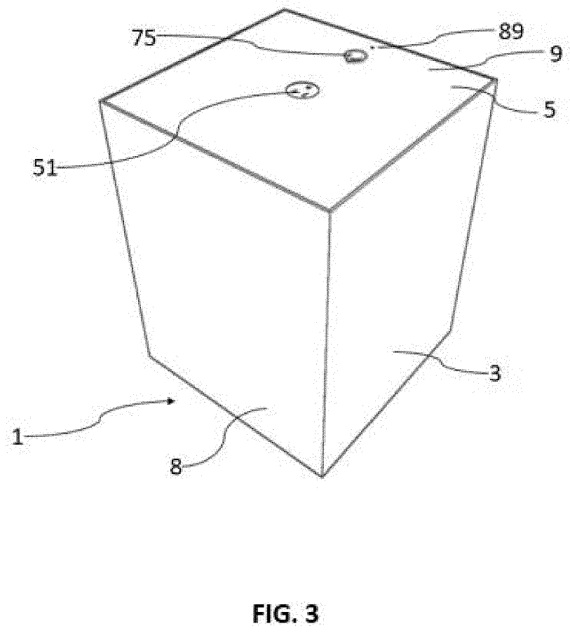

FIG. 3 is the Primary Battery Electric Generating Appliance 1 shown from the top 5, back 8 and left 3 sides. From the top side 5 we can see the main chassis lid 9, main air intake and exhaust vent 89, electrolyte container lid 75 and Electric Outlet 51.

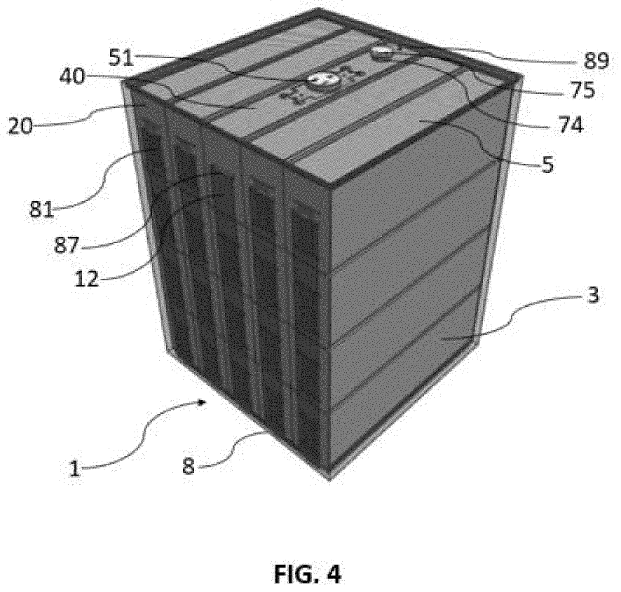

FIG. 4 is a see-through view of the Primary Battery Electric Generating Appliance 1 shown from the top 5, back 8 and left 3. The Primary Battery Electric Generating Appliance 1 is equipped with nineteen Humidified Electrolyte Primary Batteries 20 and Circuit Box 40. From back side 8 we can see the entry point for negative wires 87 through which wires run into the negative wire ducts 12 to the nineteen negative metal bands 81. From the top side 5 we can see main air intake and exhaust vent 89, refillable electrolyte container 74, electrolyte container lid 75 and electric outlet 51.

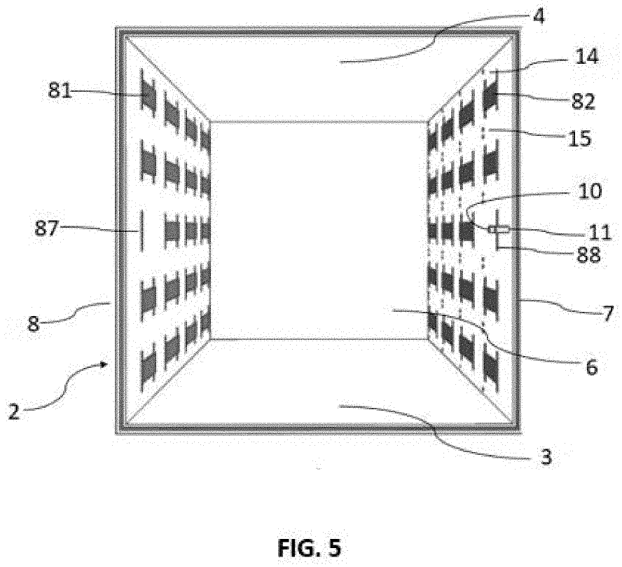

FIG. 5 is the Main Chassis 2 without the main chassis lid 9 in an aerial view that shows bottom 6, front 7, back 8, left 3 and right 4. From the back side 8 we can see the entry point for negative wires 87 and the nineteen negative metal bands 81. From the front side 7 we can see the entry point for positive wires 88 and the nineteen positive metal bands 82. From the front side 7 we can also see the main electrolyte and air input nozzle 10, main exhaust nozzle 11, the nineteen slots for the primary battery input nozzles 14 and the nineteen slots for the primary battery exhaust nozzles 15.

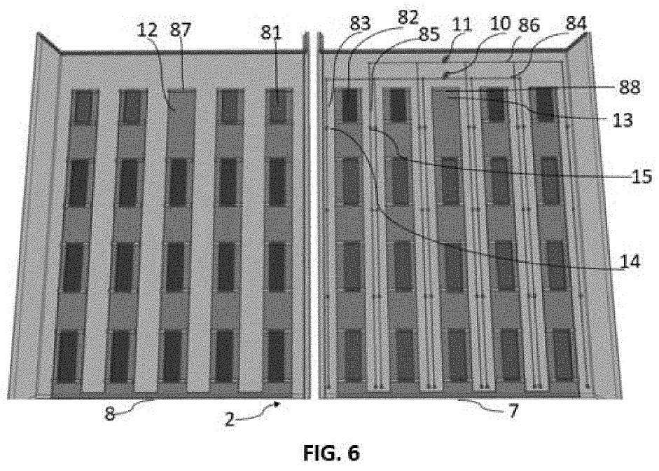

FIG. 6 is a cut out view of the front 7 and back sides 8 of the main chassis 2. From back side 8 we can see the entry point for negative wires 87 through which wires run into the negative wire ducts 12 to the nineteen negative metal bands 81. From the front side 7 we can see the entry point for positive wires 88 through which wires are run into the positive wire ducts 13 to the nineteen positive metal bands 82. From the front side 7 we can also see the main electrolyte and air input nozzle 10 that connects to horizontal input duct 84. Horizontal input duct 84 connects to the vertical input ducts 83 that supply the humidified electrolyte to the nineteen slots for the primary battery input nozzles 14. From the front side 7 we can also see main exhaust nozzle 11 that connects to horizontal exhaust duct 86. Horizontal exhaust duct 86 connects to vertical exhaust ducts 85 that allow exhaust to exit the nineteen slots for the primary battery exhaust nozzles 15.

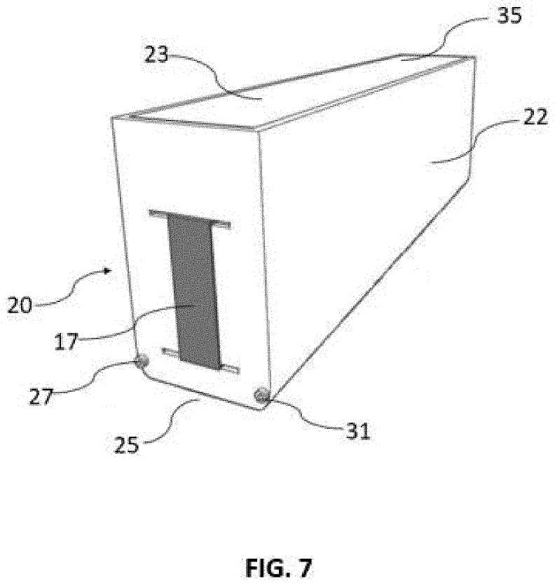

FIG. 7 is the Humidified Electrolyte Primary Battery 20 shown from the top 23, front 25 and right 22. Front side 25 has the primary battery's positive electrode 17, exhaust nozzle 27 and input nozzle 31. From the top 23 we can see primary battery lid 35.

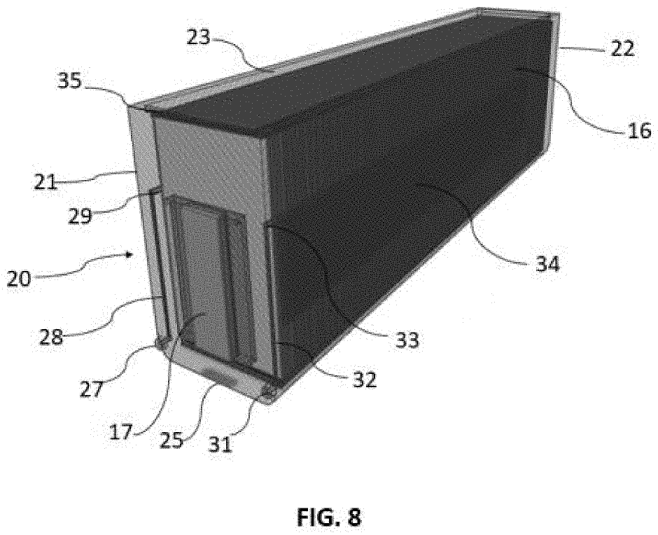

FIG. 8 is a see-through view of the Humidified Electrolyte Primary Battery 20 shown from the top 23, front 25 and right 22. From the top 23 we can see primary battery lid 35. From the front side 25 we can see the primary battery's positive electrode 17, exhaust nozzle 27 and input nozzle 31. On the left side 21 we can see vertical exhaust duct 28 and horizontal exhaust duct 29. On the right side 22 we can see vertical input duct 32, horizontal input duct 33 and one hundred and twenty-seven vertical input cell ducts 34 that supply humidified electrolyte to the one hundred and twenty-eight battery cells 16 that are arranged in series.

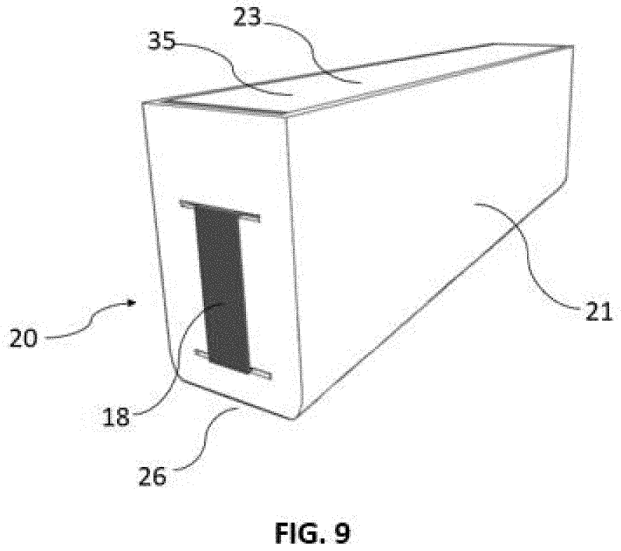

FIG. 9 is the Humidified Electrolyte Primary Battery 20 shown from the top 23, back 26 and left 21. Back side 26 has the primary battery's negative electrode 18. From the top 23 we can see the primary batteries lid 35.

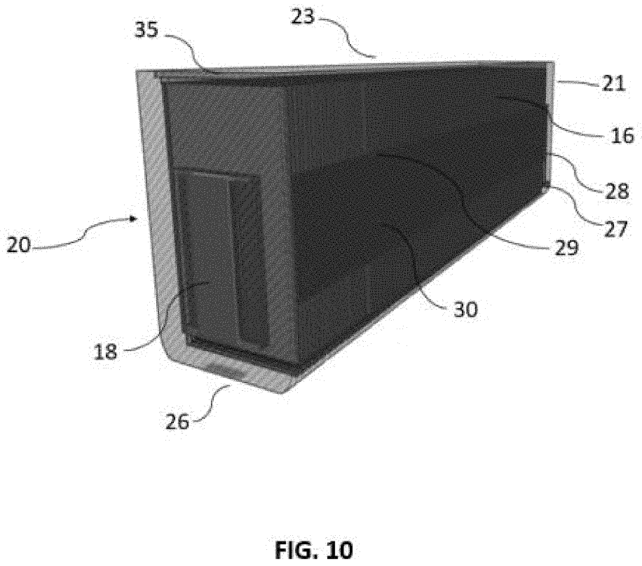

FIG. 10 is a see-through view of the Humidified Electrolyte Primary Battery 20 shown from the top 23, back 26 and left 21. Back side 26 has the primary battery's negative electrode 18. From the top 23, we can see the primary battery's lid 35. Within the Humidified Electrolyte Primary Battery 20 we can see one hundred and twenty-eight battery cells 16 arranged in series. On the left side 21 we can see exhaust nozzle 27, vertical exhaust duct 28, horizontal exhaust duct 29 and one hundred and twenty-seven vertical exhaust cell ducts 30.

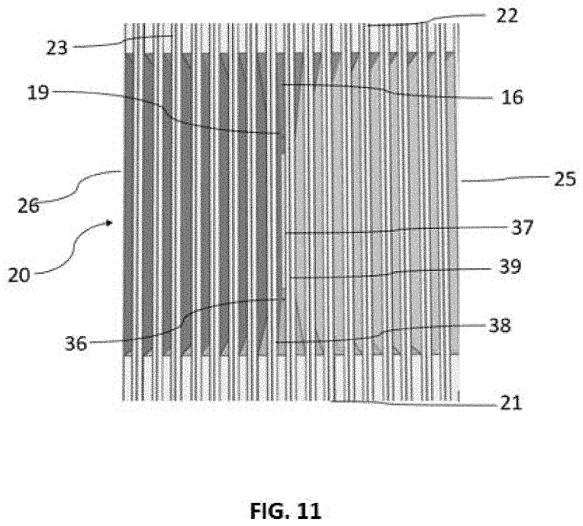

FIG. 11 is a partial aerial view of the Humidified Electrolyte Primary Battery 20 shown without the primary battery's lid 35 from top 23, left 21, right 22, front 25, and back 26. The one hundred and twenty-eight battery cells 16 arranged in series are comprised of solid negative cell plates 38, solid positive cell plates 39 and cell electrolyte cavities 37. The cell electrolyte cavities 37 are filled with a polymer which is maintained by the humidified electrolyte that is pumped into each cell from the angled input cell ducts 19 and by the angled exhaust cell ducts 36 which allow exhaust to exit each cell. The solid negative cell plates 38 and solid positive cell plates 39 separate the electrolyte in each cell electrolyte cavity 37 from the electrolyte in the other battery cells 16.

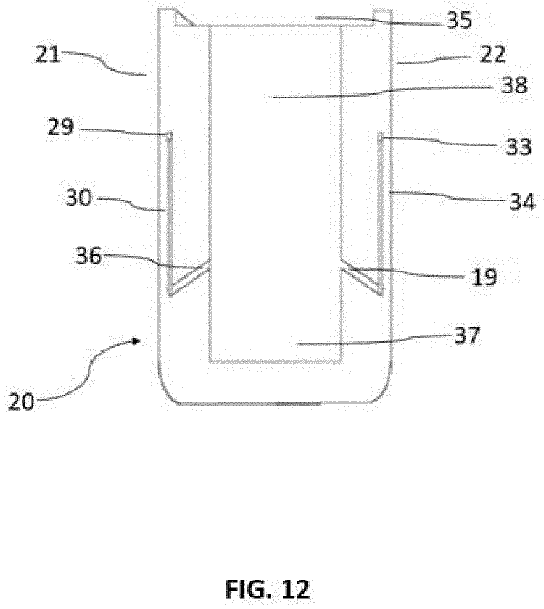

FIG. 12 is the Humidified Electrolyte Primary Battery 20 shown split in half through one of its cells shown without the primary battery's lid 35. On left side 21 we can see horizontal exhaust duct 29 connected to one of the vertical exhaust cell ducts 30. Vertical exhaust cell ducts 30 connect to angled exhaust cell ducts 36 which lead to electrolyte cavities 37 between solid negative cell plates 38 and solid positive cell plates 39 of each cell in the Humidified Electrolyte Primary Battery 20. On right side 22 we can see horizontal input duct 33 connected to one of the vertical input cell ducts 34. The vertical input cell ducts 34 connect to angled input cell ducts 19 that lead to electrolyte cavities 37 between solid negative cell plates 38 and solid positive cell plates 39 of each cell in the Humidified Electrolyte Primary Battery 20.

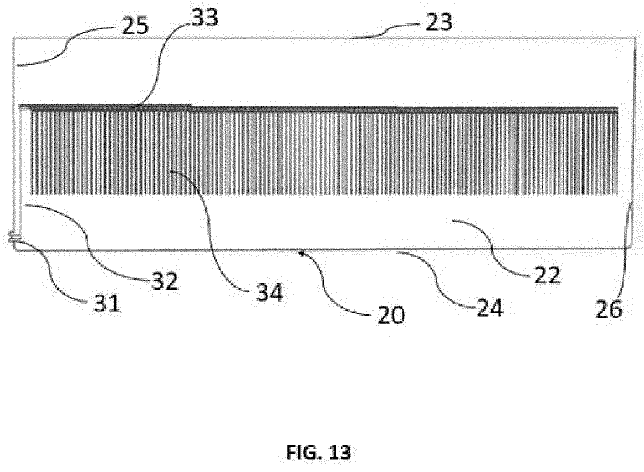

FIG. 13 is the Humidified Electrolyte Primary Battery 20 shown with its right side 22 sliced through vertical input duct 32, horizontal input duct 33, one hundred and twenty-seven vertical input cell ducts 34 and input nozzle 31. The view reveals the right 22, top 23, bottom 24, front 25 and back 26 sides.

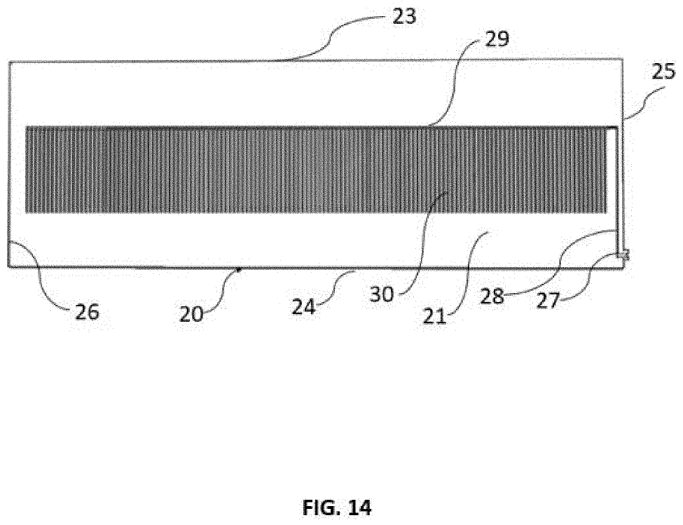

FIG. 14 is the Humidified Electrolyte Primary Battery 20 shown with its left side 21 sliced through vertical exhaust duct 28, horizontal exhaust duct 29, one hundred and twenty-seven vertical exhaust cell ducts 30 and exhaust nozzle 27. The view reveals the left 21, top 23, bottom 24, front 25 and back 26 sides.

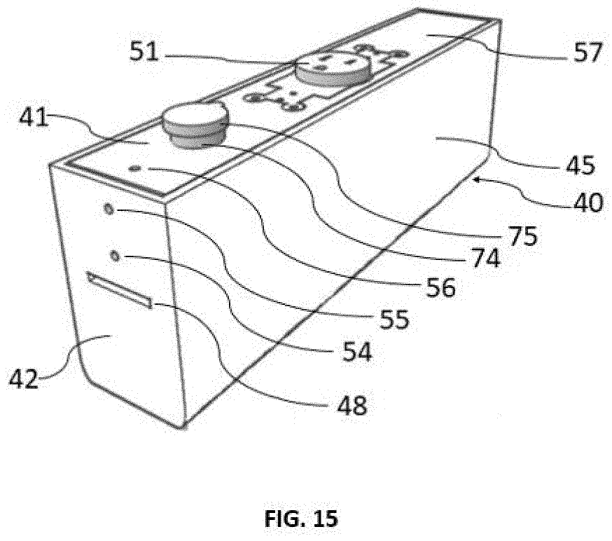

FIG. 15 is the Circuit Box 40 shown from the top 41, front 42 and right 45. Front side 42 has input hole 54, exhaust hole 55 and an entry point for positive wires 48. From the top 41 we can see electric outlet 51, refillable electrolyte container 74, electrolyte container lid 75, air intake and exhaust vent 56 and circuit box lid 57.

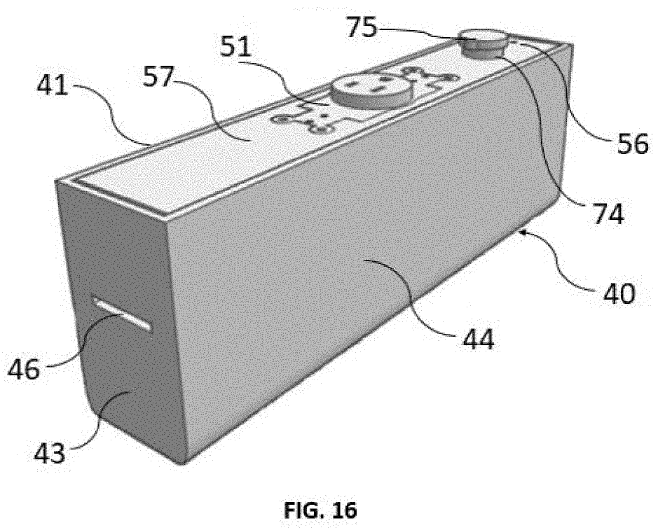

FIG. 16 is the Circuit Box 40 is shown from the top 41, back 43 and left 44. Back side 43 has an entry point for negative wires 46. From the top 41 we can see electric outlet 51, refillable electrolyte container 74, electrolyte container lid 75, air intake and exhaust vent 56 and circuit box lid 57.

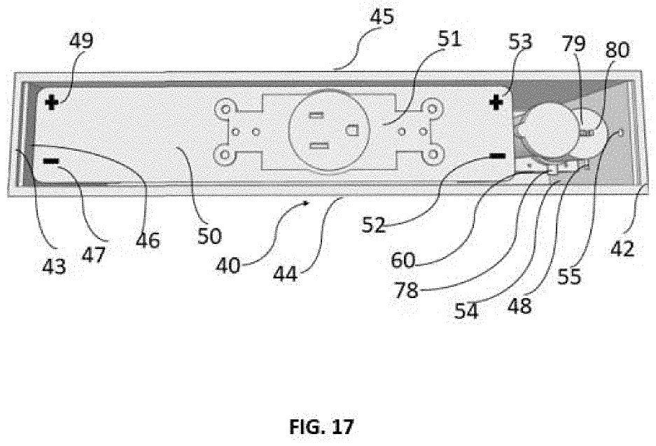

FIG. 17 is the Circuit Box 40 shown in an aerial view without the circuit box lid 57. The view shows front 42, back 43, left 44 and right 45. Circuit box 40 is comprised of a circuit module 50 and an electrolyte humidifier pump 60. Back side 43 has an entry point for negative wires 46 that come from the Humidified Electrolyte Primary Batteries 20. Negative wires from the Humidified Electrolyte Primary Batteries 20 connect to negative wire terminal 47 on circuit module 50. Front side 42 has input hole 54, exhaust hole 55 and entry point for positive wires 48. Positive wires from the Humidified Electrolyte Primary Batteries 20 connect to positive wire terminal 49 on circuit module 50. Circuit module 50 has within it, a voltage regulator circuit. a DC to AC inverter circuit and an air pump timer circuit. Negative wire terminal 47 and positive wire terminal 49 connect the voltage regulator circuit. The voltage regulator circuit is connected to the DC to AC inverter circuit and to the air pump timer circuit. The DC to AC inverter circuit powers electric outlet 51. The air pump timer circuit is connected to negative timer terminal 52 and positive timer terminal 53. A wire connects negative timer terminal 52 to negative air pump electrode 79. A wire connects positive timer terminal 53 to positive air pump electrode 80. Main exhaust nozzle 11 enters circuit box 40 through exhaust hole 55. Main electrolyte and air input nozzle 10 enters circuit box 40 through input hole 54. Electrolyte humidifier pump 60 pumps the humidified air and electrolyte mixture through a hose that connects output nozzle 78 to main electrolyte and air input nozzle 10.

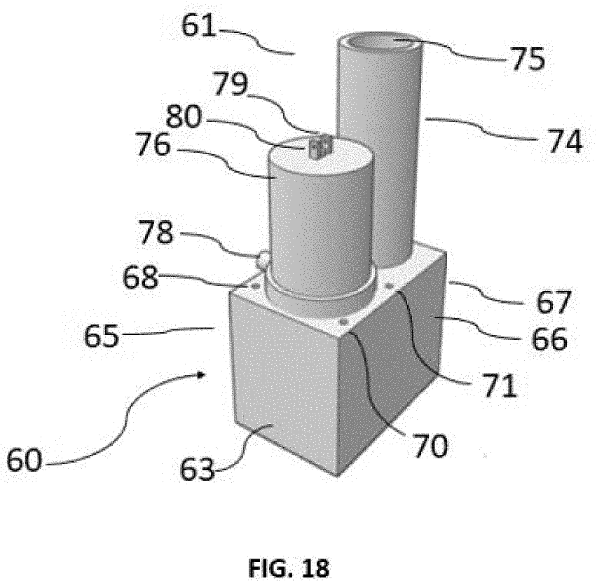

FIG. 18 is the Electrolyte Humidifier Pump 60 shown from the top 61, front 63, left 65 and right 66. This view of the Humidifier Air Pump 60 shows air duct A 68, air duct C 70 and air duct D 71 on chassis 67. Electrolyte Humidifier Pump 60 has air pump 76 and refillable electrolyte container 74. Refillable electrolyte container 74 is shown without its electrolyte container lid 75. Air pump 76 is shown with output nozzle 78 facing left side 65 and has negative air pump electrode 79 and positive air pump electrode 80.

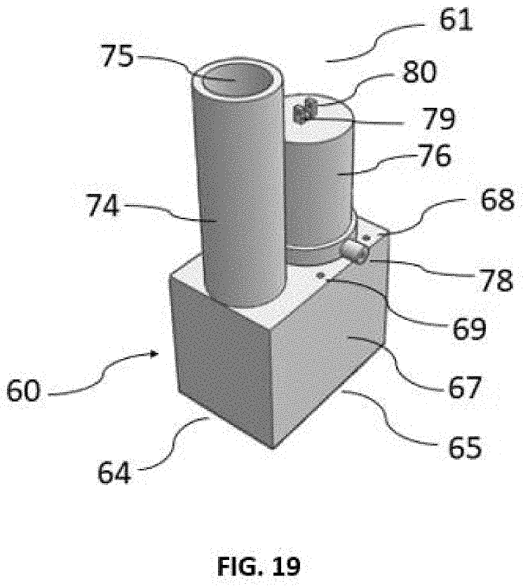

FIG. 19 is the Electrolyte Humidifier Pump 60 shown from the top 61, back 64 and left 65. This view of the Electrolyte Humidifier Pump 60 shows air duct A 68 and air duct B 69 on chassis 67. Electrolyte Humidifier Pump 60 has air pump 76 and refillable electrolyte container 74. Refillable electrolyte container 74 is shown without its electrolyte container lid 75. Air pump 76 is shown with output nozzle 78 facing left side 65 and has negative air pump electrode 79 and positive air pump electrode 80.

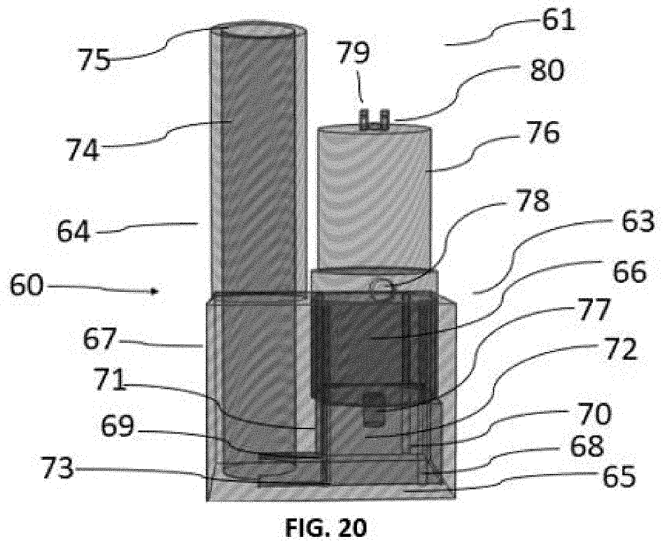

FIG. 20 is a see-through view of the Electrolyte Humidifier Pump 60 shown from top 61, front 63, back 64, left 65 and right 66. Electrolyte Humidifier Pump 60 has chassis 67 with four air ducts, air duct A 68 and air duct B 69 are located on left side 65, air duct C 70 and air duct D 71 are located on right side 66. Chassis 67 has a humidification chamber 72 that is supplied with air through the four air ducts, air duct A 68 air duct B 69, air duct C 70 and air duct D 71. Humidification chamber 72 is supplied with an electrolyte through electrolyte duct 73 that connects to the refillable electrolyte container 74. Refillable electrolyte container 74 is shown without its electrolyte container lid 75. Electrolyte Humidifier Pump 60 is equipped with air pump 76 which has intake nozzle 77 and output Nozzle 78. Intake nozzle 77 takes in the humidified air and electrolyte mixture from humidification chamber 72. Output nozzle 78 pumps the humidified air and electrolyte mixture to the Humidified Electrolyte Primary Batteries 20 through the network of input ducts. Air pump 76 is turned on and off through negative air Pump electrode 79 and positive air pump electrode 80.

While the present invention has been illustrated and described with reference to certain exemplary embodiments, those of ordinary skill in the art would appreciate that various modifications and changes can be made to the described embodiments without departing from the spirit and scope of the present invention, as defined in the following claims.

What is claimed is:

1. An electric generating appliance that supplies a fixed voltage through a voltage regulator connected to one or more primary batteries comprised of cells made of solid metal anodes and solid metal cathodes where the metal for the solid metal anodes is a different type of metal than the metal used for the solid metal cathodes and where each cell has an output duct to expel air or aqueous electrolyte and an input duct to receive air, aqueous electrolyte, or a humidified electrolyte from a circuit-controlled pump connected to a refillable electrolyte container.

2. An electric generating appliance as in claim 1, wherein the primary battery cells are placed in series to provide thousands of volts to the voltage regulator which then supplies a fixed voltage.

3. An electric generating appliance as in claim 2, equipped with an inverter that converts the DC voltage from the voltage regulator to AC voltage.

4. An electric generating appliance as in claim 3, wherein an electric outlet is connected to the inverter.

5. An electric generating appliance as in claim 4, wherein the voltage regulator and inverter are housed in a circuit box which can be replaced with a circuit box configured to supply a required AC frequency and voltage.

6. An electric generating appliance as in claim 5, wherein the inverter is set to 50 hz or 60 hz.

7. An electric generating appliance as in claim 6, w the voltage regulator supplies a fixed voltage of 110 V or greater.

8. An electric generating appliance as in claim 7, wherein the primary battery is replaceable.

9. An electric generating appliance as in claim 8, wherein the primary battery has output nozzles or ports to expel air or electrolyte from the primary battery's cells.

10. An electric generating appliance as in claim 9, wherein the primary battery has input nozzles or ports to receive air, electrolyte, or a humidified electrolyte for the primary battery's cells.

11. An electric generating appliance as in claim 10, wherein the chassis of the electric generating appliance has built-in input nozzles or ports to connect to the primary battery's input nozzles or ports.

12. An electric generating appliance as in claim 11, wherein the chassis of the electric generating appliance has built-in output nozzles or ports to connect to the primary battery's output nozzles or ports.

13. An electric generating appliance as in claim 12, wherein the chassis for the electric generating appliance has built-in negative metal connectors that can be connected to the negative electrodes on the primary battery and built-in ducts for the negative wires.

14. An electric generating appliance as in claim 13, wherein the chassis for the electric generating appliance has built-in positive metal connectors that can be connected to the positive electrodes on the primary battery and built-in ducts for the positive wires.

15. An electric generating appliance as in claim 14, wherein the chassis for the electric generating appliance has built-in ducts to expel air or electrolyte from the primary battery.

16. An electric generating appliance as in claim 15, wherein the chassis for the electric generating appliance has built-in ducts to supply air, electrolyte, or a humidified electrolyte the primary battery.

17. An electric generating appliance as in claim 16 that has enough power to run a television, freezer, refrigerator, power tools, lights, and other heavy loads in remote sites or when wired into a facility's electric panels.

18. An electric generating appliance as in claim 17, wherein the cells are pre-filled with a polymer between the solid metal anodes and solid metal cathodes.
